(19) United States
(12) Patent Application Publication
(10) Pub. No.: US 2008/0270652 A1
(43) Pub. Date: Oct. 30, 2008

(54) System and method of tamper-resistant control

(76) Inventor: Jeffrey Kevin Jeansonne, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,184

(22) Filed: Apr. 30, 2007

(51) Int. Cl. G06F 13/00

(52) U.S. Cl. 710/108

(57) ABSTRACT

A method of tamper-resistant configuration control for a system, the method comprising reading a flag from a memory of an electronic device, the flag indicating an enable/disable state of at least one component device of the electronic device, setting a register in memory to a disable state for the at least one component device in response to the flag indicating a disabled state for the at least one component device, and locking the register.

### BACKGROUND

When an owner of a computer allows another person to use the computer, such as an employer providing a computer for use by an employee, the computer owner may wish to restrict the use of certain ports and/or devices. For example, an employer may wish to restrict the ability of employees to copy data from the computer device. Some operating systems provide methods of disabling ports and/or devices; however, experienced users may defeat the software operating system security protocols and enable the ports and peripheral devices.

### BRIEF DESCRIPTION OF THE DRAWINGS

FIG. 1 is a block diagram of an electronic device comprising a tamper-resistant control for an electronic device; and

FIG. 2 is a flow diagram illustrating an embodiment of a tamper-resistant control method.

### DETAILED DESCRIPTION OF THE DRAWINGS

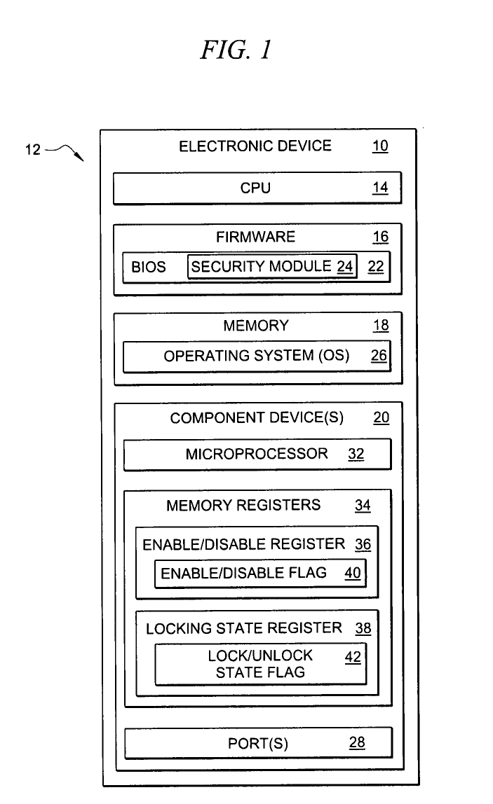

FIG. 1 is a block diagram of an electronic device 10 comprising a tamper-resistant control system 12. Electronic device 10 may comprise any type of electronic device such as, but not limited to, a desktop computer, portable notebook computer, convertible portable computer, tablet computer, workstation or server.

In the embodiment illustrated in FIG. 1, electronic device 10 comprises a central processing unit (CPU) 14, firmware 16, a memory 18 and component device 20. In FIG. 1, firmware 16 is coupled to CPU 14, memory 18 and component device(s) 20. Firmware 16 is configured to provide boot-up functionality for electronic device 10. For example, in some embodiments, firmware 16 executes initial power-on instructions such as configuring CPU 14 and causing CPU 14 to begin executing instructions at a predetermined time. Firmware 16 may comprise a basic input/output system (BIOS) 22; however it should be understood that firmware 16 may comprise other systems or devices for providing boot-up functionality. In the embodiment illustrated in FIG. 1, BIOS 16 comprises a security module 24 to limit access to BIOS 22 solely to users having a password. Security module 24 may comprise hardware, software, or a combination of hardware and software, and is used to verify or authenticate the identity of a user attempting to access BIOS 22. Memory 18 may comprise volatile memory, non-volatile memory and permanent storage. In FIG. 1, memory 18 comprises an operating system (OS) 26 that may be loaded and/or otherwise executed by CPU 14. Embodiments of system 12 enable a setting to be applied or set via firmware 16 for component device(s) 20 to indicate component device(s) 20 as either being enabled (e.g., able to be used and/or otherwise accessed for use thereof by OS 26) or disabled (e.g., disabled and/or otherwise unavailable to OS 26 so that OS 26 cannot readily access and/or interact with component device(s) 20). In operation, tamper-resistant configuration control system 12 is configured to disable and lock one or more ports 28 on component device(s) 20 via a command issued from BIOS 22 prior to loading OS 26.

In the embodiment illustrated in FIG. 1, component device(s) 20 comprises any type of device such as, but not limited to, a multi-peripheral component interconnect (PCI) device, a universal serial bus (USB) device, a modem, a microphone, a digital video disk (DVD) drive, or any other type of device. In the embodiment illustrated in FIG. 1, component device(s) 20 comprises a microprocessor 32, one or more memory registers 34, and device port(s) 28 for facilitating communicative engagement with a device external to the particular component device 20. Memory registers 34 comprise information stored by microprocessor 32 associated with various preset and/or operating parameters of component device(s) 20. In the embodiment illustrated in FIG. 1, memory registers 34 comprise at least an enable/disable register 36 and a locking state register 38. In FIG. 1, enable/disable register 36 comprises an enable/disable flag 40 stored in non-volatile memory thereof. Enable/disable flag 40 is used to indicate a setting for component device(s) 20 as either being enabled for use or disabled for non-use. For example, enable/disable flag 40 is used to indicate whether port 28 on a particular component device 20 is enabled for use or disabled for non-use. Thus, in some embodiments, if enable/disable flag 40 is set to “YES,” the setting for device 20 comprises an enabled setting to enable use of device 20. Correspondingly, if enable/disable flag 40 is set to “NO,” the setting for device 20 comprises a disabled setting to otherwise disable device 20 to prevent use thereof. It should be understood that flag 40 may be otherwise set for indicating the enabled or disabled state of device 20.

In FIG. 1, locking state register 38 comprises a lock/unlock flag 42 stored in non-volatile memory thereof. Lock/unlock flag 42 is used to indicate whether the enable/disable register 36 is locked or unlocked. Thus, in some embodiments, if lock/unlock flag 42 is set to “YES,” the setting for enable/disable register 36 is locked (to write-protect registers 36 and 38 and/or otherwise prevent changes thereto).

During booting of electronic device 10 (e.g., in response to a power-on event or wake event from a hibernation, sleep or other type of reduced-power mode), BIOS 22 determines whether enable/disable flag 40 is set to “YES,” thereby indicating an enabled or disabled status setting for one or more component devices 20. During manufacturing or building of electronic device 10, enable/disable register 36 is set to an “enabled” state until, for example, an IT administrator or another person changes setting 36 to a disabled state via BIOS 22. Accordingly, in response to BIOS 22 determining that register 36 has been changed to “disabled”, BIOS 22 issues a disable command to the particular component device 20 (e.g., setting a disable register in volatile memory), and a lock command to lock the state of registers 36 and 38 before BIOS 22 transfers control of electronic device 10 to OS 26. Thus, embodiments of system 12 lock the state of registers 36 and 38 (e.g., write-protects registers 36 and 38) before transferring control of electronic device 10 to OS 26 to prevent unauthorized tampering with electronic device 10. Thus, in the event a user resets electronic device 10 (e.g., by initiating a hard reset), BIOS 22 will reconfigure the particular component device 20 (e.g., reset a disable register in volatile memory) and issue a lock command to lock the state of registers 36 and 38 before BIOS 22 transfers control of electronic device 10 to OS 26.

BIOS 22 is preferably configured to interface with OS 26 to report to OS 26 the state/status of component device(s) 20. BIOS 22 is preferably configured to, in response to detecting a disabled setting for component device(s) 20, indicate to OS 26 a disabled state on electronic device 10. Thus, based on the status reporting received from BIOS 22 indicating a disabling of component device(s) 20, OS 26 does not load any drivers associated with component device(s), thereby preventing OS 26 and/or from accessing and/or otherwise interfacing with component device(s) 20. Thus, in some embodiments, the disabled component device 20 is reported as not being present on electronic device 10.

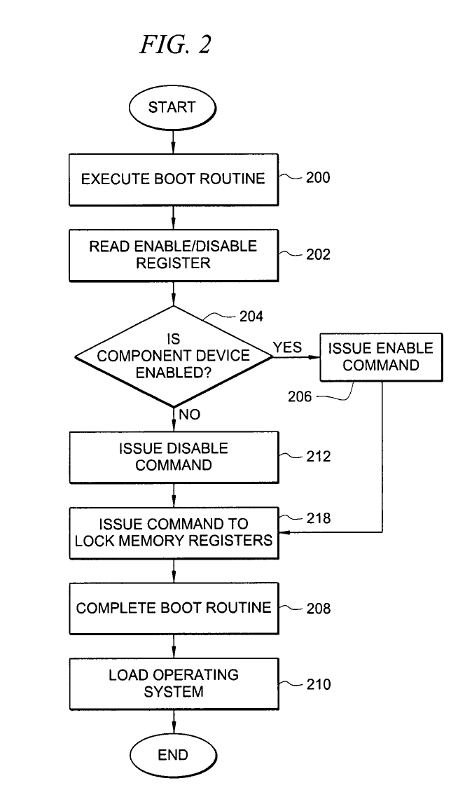

FIG. 2 is a flow diagram illustrating an embodiment of a tamper-resistant configuration control method. In FIG. 2, the method begins at block 200, wherein BIOS 22 executes a boot routine (e.g., in response to a power-on or wake event). At block 202, BIOS 22 reads enable/disable register 36 to determine the configuration set-up for component device 20 (e.g., whether component device 20 is set as enabled or disabled). At decision block 204, BIOS 22 determines whether enable/disable flag 40 indicates if the state of register 36 is enabled. If enable/disable flag 40 indicates that the state of register 36 is enabled, BIOS 22 sends a command to microprocessor 32 to enable port 28 of device 20 or otherwise report to OS 26 the availability of device 20, as indicated at block 206. The method proceeds to block 218 wherein BIOS 22 issues a command to lock registers 36 and 38. The method continues to block 208 wherein BIOS 22 completes any remaining functions associated with the boot routine. At block 210, BIOS loads operating system 26.

If at decision block 204 BIOS 22 determines that enable/disable flag 40 indicates the state of register 36 is disabled, BIOS 22 sends a command to microprocessor 32 to disable device 20 for non-use, as indicated at block 212. The method proceeds to block 218 where BIOS 22 issues a command to lock memory registers 36 and 38 (e.g., issues command to lock/write-protect registers 36 and 38). The method proceeds to block 208, wherein BIOS 22 completes any remaining functions associated with the boot routine. At block 210, BIOS loads operating system 26.

Embodiments of system 12 may be implemented in software and can be adapted to run on different platforms and operating systems. In particular, functions implemented by system 12, for example, may be provided by an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium.

Thus, embodiments of tamper-resistant configuration control system 12 enable configuration (e.g., an enabled or disabled configuration) changes of one or more component devices 20 through via BIOS 22 and lock the state of such component devices to prevent unauthorized enabling/tampering of such component device(s).

What is claimed is:

1. A method of tamper-resistant configuration control for a system, the method comprising:
reading a flag from a memory of an electronic device, the flag indicating an enable/disable state of at least one component device of the electronic device;
setting a register in memory to a disable state for the at least one component device in response to the flag indicating a disabled state for the at least one component device; and
locking the register.

2. The method of claim 1, wherein reading the flag comprises reading a flag from non-volatile memory.

3. The method of claim 1, wherein setting the register comprises setting the register in volatile memory.

4. The method of claim 1, wherein reading the flag comprises reading a flag by firmware.

5. The method of claim 4, wherein reading the flag by the firmware comprises reading the flag with a basic input/output system (BIOS).

6. The method of claim 1, wherein locking the register comprises write-protecting the memory.

7. The method of claim 1, further comprising loading an operating system after locking the register.

8. A tamper-resistant configuration system, comprising:
an electronic device having a memory register comprising at least one flag, the flag indicating an enable/disable state for the at least one component device of the electronic device; and
a firmware configured to read the flag and write-protect the memory register in response to the flag indicating a disable state for the at least one component device.

9. The system of claim 8, wherein the firmware comprises a basic input/output system (BIOS).

10. The system of claim 8, wherein the firmware is configured to read the flag and write-protect the memory register prior to booting an operating system.

11. The system of claim 8, wherein the device comprises a peripheral component interconnect (PCI) device.

12. The system of claim 8, wherein the write-protected memory register is configured to be write-protected against the OS.

13. The system of claim 8, wherein the memory comprises non-volatile memory.

14. A computer-readable medium having stored thereon an instruction set to be executed, the instruction set, when executed by a processor, causes the processor to:
read a flag from memory of an electronic device, the flag indicating an enable/disable state of at least one component device of the electronic device;
set a register in memory to a disable state for the at least one component in response to the flag indicating a disabled state for the at least one component device; and
lock the register.

15. The computer readable medium of claim 14, wherein the instruction set, when executed by the processor, causes the processor to read the flag from non-volatile memory.

16. The computer readable medium of claim 14, wherein the instruction set, when executed by the processor, causes the processor to set the register in volatile memory.

17. The computer readable medium of claim 14, wherein the instruction set, when executed by the processor, causes the processor to read the flag from memory by firmware.

18. The computer readable medium of claim 14, wherein the instruction set, when executed by the processor, causes the processor to read the flag from memory with a basic input/output system (BIOS).

19. The computer readable medium of claim 14, wherein the instruction set, when executed by the processor, causes the processor to write-protect the register.

20. The computer readable medium of claim 14, wherein the instruction set, when executed by the processor, causes the processor to load an operating system after locking the register.
